(19) United States
(12) Patent Application Publication
(10) Pub. No.: US 2018/0051468 A1
(43) Pub. Date: Feb. 22, 2018

(54) CUSTOMIZABLE AND FUNCTIONAL ELEVATOR CAR HANDRAIL

(71) Applicant: Otis Elevator Company, Farmington, CT (US)

(72) Inventors: Frederic Beauchaud, Coullons (FR); Franck Dominguez, Loiret (FR)

(21) Appl. No.: 15/667,736

(22) Filed: Aug. 3, 2017

(30) Foreign Application Priority Data
Aug. 22, 2016 (EP) 16306070.0

(51) Int. Cl. E04F 11/18; F21S 4/20

(52) U.S. Cl. CPC E04F 11/18; F21W 2111/08; E04F 2011/1868; F21S 4/20

(57) ABSTRACT

Customizable elevator car handrails are provided that include a first mounting frame attachable to a panel of an elevator car and a first rail module removably attached to the first mounting frame. The first rail module having includes a housing having a first contact surface, a second contact surface opposing the first contact surface, an exterior function surface extending between the first contact surface and the second contact surface, an interior function surface extending between the first and second contact surfaces, and a module internal space defined by the housing, and module components disposed in the module internal space of the housing and configured to provide a module functionality.

### CROSS-REFERENCE TO RELATED APPLICATIONS

This application claims the benefit of European Application No. 16306070.0 filed Aug. 22, 2016, which is incorporated herein by reference in its entirety.

### BACKGROUND

The subject matter disclosed herein generally relates to elevator car handrails and, more particularly, to customizable elevator car handrails. Handrails of elevator cars provide a structure which a passenger within the elevator car can lean upon or otherwise use for support of the passenger.

### SUMMARY

According to one embodiment, a customizable elevator car handrail is provided. The customizable elevator car handrail includes a first mounting frame attachable to a panel of an elevator car and a first rail module removably attached to the first mounting frame. The first rail module includes a housing having a first contact surface, a second contact surface opposing the first contact surface, an exterior function surface extending between the first contact surface and the second contact surface, an interior function surface extending between the first and second contact surfaces, and a module internal space defined by the housing and module components disposed in the module internal space of the housing and configured to provide a module functionality.

In addition to one or more of the features described above, or as an alternative, further embodiments of the customizable elevator handrail may include that the exterior function surface includes at least one aperture to enable the module functionality to be provided into the elevator car.

In addition to one or more of the features described above, or as an alternative, further embodiments of the customizable elevator handrail may include a second mounting frame attachable to the panel, wherein the rail module is removably attached between the first mounting frame and the second mounting frame.

In addition to one or more of the features described above, or as an alternative, further embodiments of the customizable elevator handrail may include a structural member removably attached to the first mounting frame and the rail module.

In addition to one or more of the features described above, or as an alternative, further embodiments of the customizable elevator handrail may include that the structural member is connected between the rail module and the first mounting frame.

In addition to one or more of the features described above, or as an alternative, further embodiments of the customizable elevator handrail may include that the structural member is hollow.

In addition to one or more of the features described above, or as an alternative, further embodiments of the customizable elevator handrail may include electrical lines installed within the first mounting frame and connecting the rail module to a power source.

In addition to one or more of the features described above, or as an alternative, further embodiments of the customizable elevator handrail may include that the first contact surface of the housing includes at least one connector, the electrical lines electrically connected to the at least one connector.

In addition to one or more of the features described above, or as an alternative, further embodiments of the customizable elevator handrail may include a second rail module attached to the first mounting frame and/or the first rail module.

In addition to one or more of the features described above, or as an alternative, further embodiments of the customizable elevator handrail may include that the module functionality is at least one of (i) supplying or diffusing a scent, air freshener, or perfume, (ii) providing lighting, (iii) providing audio, or (iv) enabling passenger interaction.

In addition to one or more of the features described above, or as an alternative, further embodiments of the customizable elevator handrail may include that, when the module functionality is supplying or diffusing a scent, air freshener, or perfume, the customizable elevator car handrail further includes a scent source connected to the rail module to supply the scent, air freshener, or perfume.

In addition to one or more of the features described above, or as an alternative, further embodiments of the customizable elevator handrail may include that, when the module functionality is enabling passenger interaction, the rail module is rotatable and/or a scroll wheel.

In addition to one or more of the features described above, or as an alternative, further embodiments of the customizable elevator handrail may include that rotation of the rail module or scrolling of the scroll wheel adjusts a level of functionality of a different rail module.

In addition to one or more of the features described above, or as an alternative, further embodiments of the customizable elevator handrail may include a support element installed to the first mounting frame and supporting the first rail module.

In addition to one or more of the features described above, or as an alternative, further embodiments of the customizable elevator handrail may include that the housing has a central aperture and the support element passes through the central aperture to support the rail module.

Technical effects of embodiments of the present disclosure include a customizable elevator car handrail that enables different functionality to be added to the elevator car handrail while maintaining structural use of the elevator car handrail.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2A is an elevation schematic illustration of an elevator car panel that can employ embodiments disclosed herein;

FIG. 2B is an elevation schematic illustration of another elevator car panel that can employ embodiments disclosed herein;

FIG. 3A is an isometric illustration of a customizable elevator car handrail in accordance with a non-limiting embodiment of the present disclosure;

FIG. 3B is an exploded illustration of the customizable elevator car handrail of FIG. 3A;

FIG. 3C is a first side illustration of a rail module separated from the customizable elevator car handrail of FIG. 3A;

FIG. 3D is a second side illustration of the rail module of FIG. 3C;

FIG. 3E is an illustration of the rail module of FIG. 3C with a side surface removed illustrating an interior of the rail module;

FIG. 4 is a schematic illustration of a customizable elevator car handrail in accordance with another embodiment of the present disclosure;

FIG. 5 is a schematic illustration of a customizable elevator car handrail in accordance with another embodiment of the present disclosure;

FIG. 6 is a schematic illustration of a customizable elevator car handrail in accordance with another embodiment of the present disclosure;

FIG. 7 is a schematic illustration of a customizable elevator car handrail in accordance with another embodiment of the present disclosure; and

FIG. 8A is a schematic illustration of a rail module in accordance with an embodiment of the present disclosure;

FIG. 8B is an alternative schematic illustration of the rail module of FIG. 8A; and

FIG. 9 is a set of schematic illustrations of different exterior function surfaces that can be used with rail modules of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “##” that is shown in FIG. X may be labeled “X##” and a similar feature in FIG. Z may be labeled “Z##.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

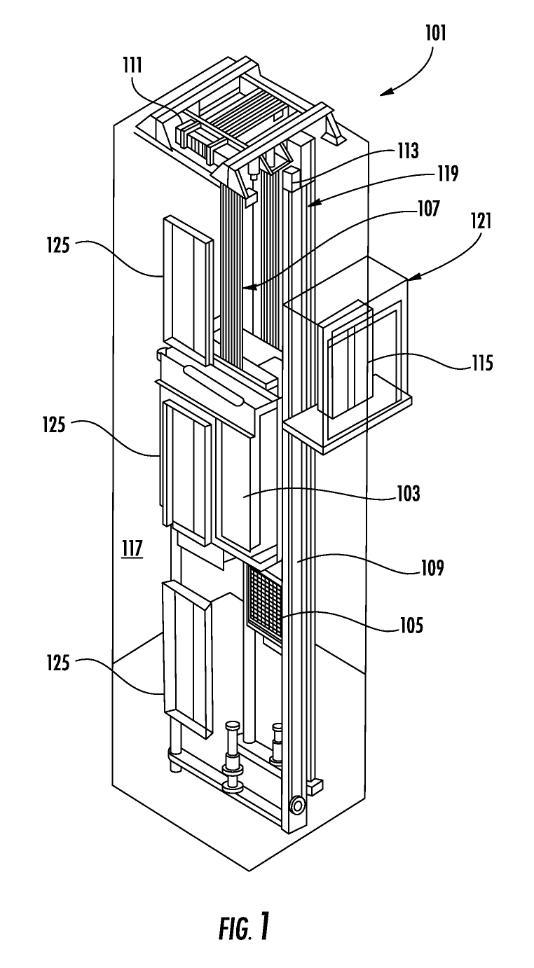

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

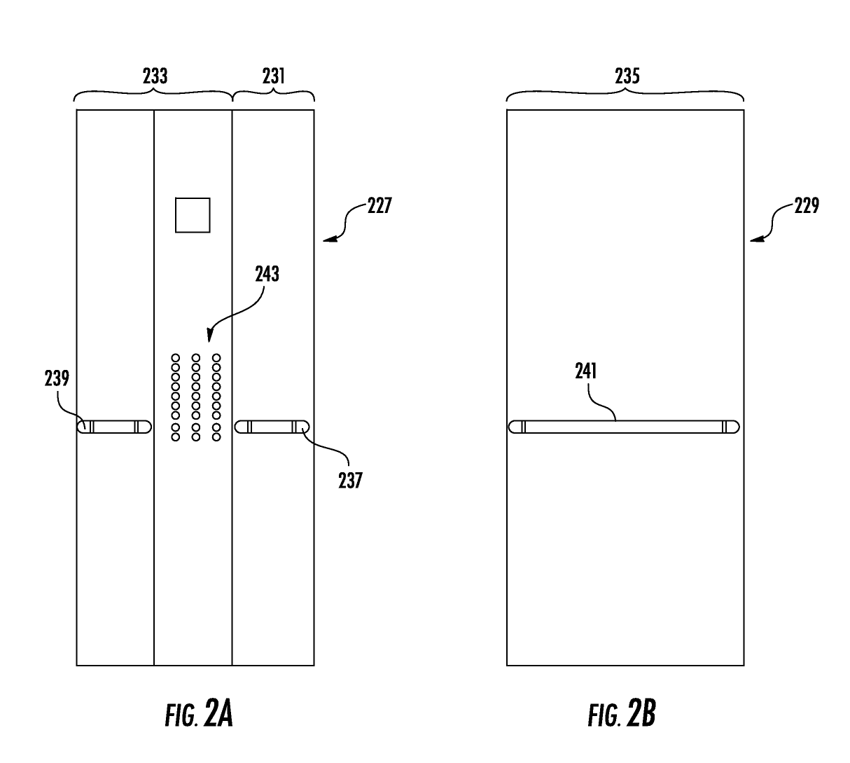

Turning to FIGS. 2A and 2B, schematic illustrations of elevator car panels 227, 229 that can employ embodiments described herein are shown. FIG. 2A shows a front elevation schematic view of a first elevator car panel 227. FIG. 2B shows a front elevation schematic view of a second elevator car panel 229. The first elevator car panel 227, as shown, includes two subpanels 231, 233, wherein a first subpanel 231 forms about a third of the elevator car panel 227 and the second subpanel 233 forms about two-thirds of the elevator car panel 227. That is, the first subpanel 231 and the second subpanel 233 are configured to form a wall of an elevator car. The two subpanels 231, 233, in some configurations, are parts of a solid or continuous elevator car panel, and thus are fixedly connected or are subparts of a continuous wall. The second elevator car panel 229 is formed with a single subpanel 235.

As shown, the first subpanel 231 of the first elevator car panel 227 includes an associated first handrail 237 and the second subpanel 233 includes an associated second handrail 239. The second elevator car panel 229 includes a third handrail 241. The handrails 237, 239, 241 are mounted to the respective subpanels 231, 233, 235 of the elevator car panels 227, 229 and provide users or passengers of the elevator to have a handrail to provide support or other function. Accordingly, ends of the handrails 237, 239, 241 are fixedly attached to, mounted to, and supported by the respective subpanels 231, 233, 235. Further, as shown, the second subpanel 233 of the first elevator car panel 227 includes an operation or control section 243. The control section 243, as shown, includes a number of buttons that are used to enable a passenger to select a destination floor, and may also include emergency buttons, or other buttons as known in the art.

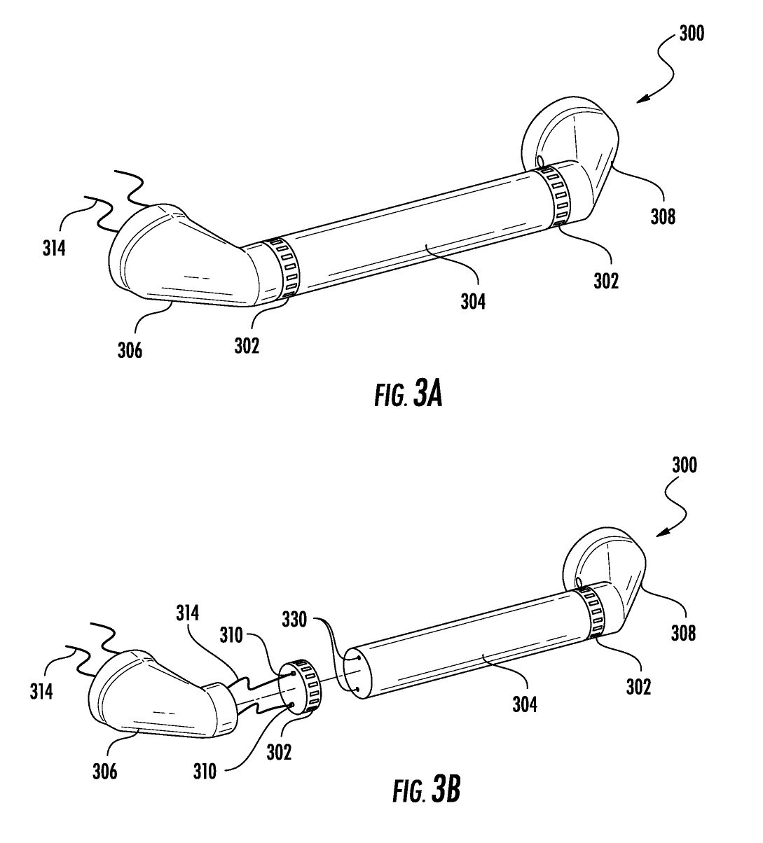

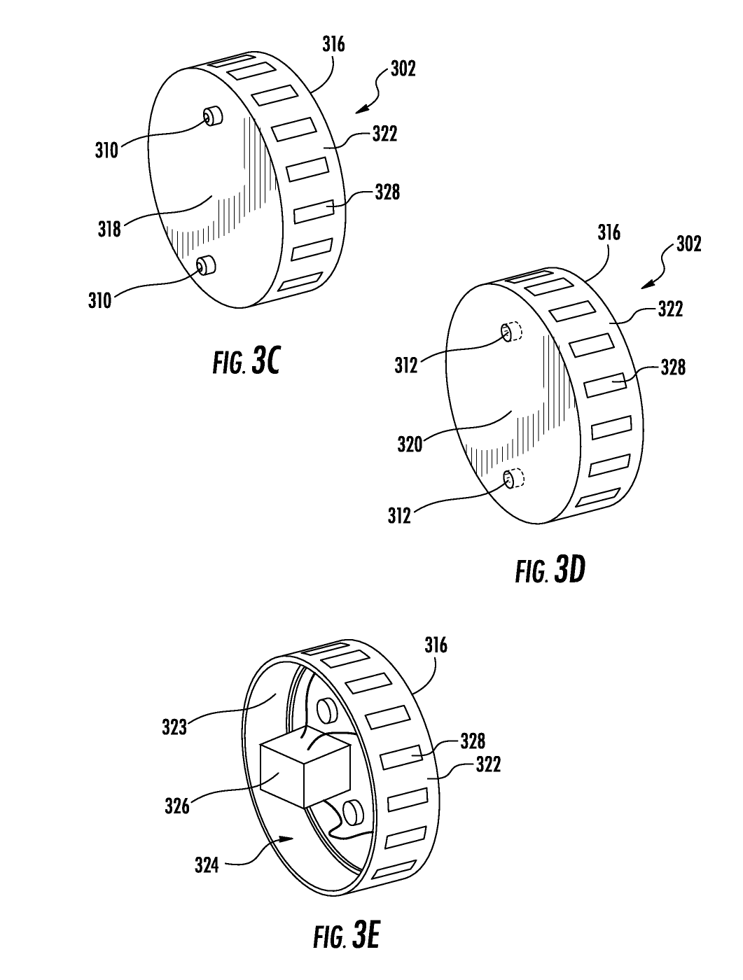

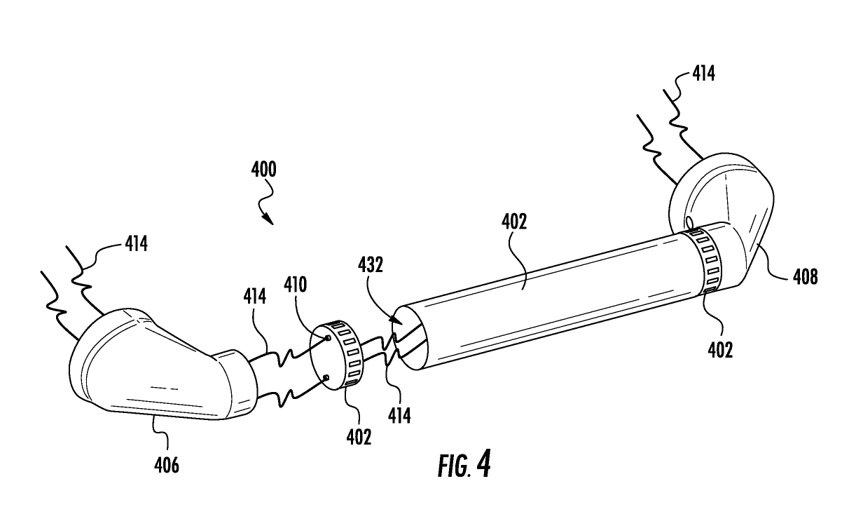

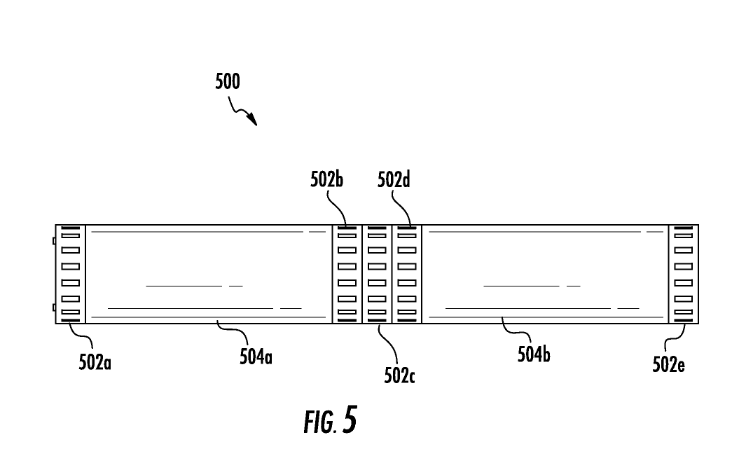

Turning now to FIGS. 3A-3E, a customizable elevator handrail 300 in accordance with a non-limiting embodiment of the present disclosure is shown. FIG. 3A illustrates the customizable elevator handrail 300 in an assembled configuration that can be mounted to or attached to a panel or subpanel of an elevator car. FIG. 3B illustrates an exploded view of the customizable elevator handrail 300. FIG. 3C illustrates a first side view of a rail module 302 and FIG. 3D illustrates a second side view of the rail module 302. FIG. 3E illustrates an interior of the rail module 302.

As shown, the customizable elevator handrail 300 includes two rail modules 302 with a structural member 304 located therebetween. At opposing ends of the customizable elevator handrail 300 are a first mounting frame 306 and a second mounting frame 308. The mounting frames 306, 308, the structural member 304, and the rail modules 302 are connectable to form a handrail that can be installed to a panel or subpanel of an elevator car. The mounting frames 306, 308 are configured to fixedly attach to a panel of an elevator car and support the structural member 304 and the rail modules 302 between the first mounting frame 306 and the second mounting frame 308.

The rail modules 302 are sized, shaped, and otherwise configured to be connected between the structural member 304 and the mounting frames 306, 308. The connection between the rail modules 302 and the structural member 304 and/or the mounting frames 306, 308 can be by threaded connection, interference fit, fastener, etc. as known in the art. The rail modules 302 are customizable modules that can provide one or more features and thus enable customizable elevator handrails. For example, in some embodiments one or more of the rail modules 302 can be configured to supply or diffuse a scent, air freshener, perfume, etc., provide lighting, provide audio (e.g., music, instructions, news, etc.), enable passenger interaction, or may provide other function that can be provided on the customizable elevator handrail 300. Passenger interaction, in some embodiments, can be provided by the rail module operating as a scroll wheel in order to interact with the elevator or features thereof. For example, some non-limiting interactive experiences that can be provided with an interactive rail module include, but are not limited to choice of the elevator car ambiance, setup of elevator car or rail module lighting (e.g., intensity or color of the light), choice in a predefined style of playlist music, choice of a control operating panel display theme, etc.

The rail modules 302 can be electrically powered and thus, in some embodiments, can include a power supply. In some embodiments, for example as shown in FIGS. 3A-3E, the rail modules 302 can include connectors 310, 312. The connectors 310, 312 can be electrical connectors, plugs, or ports that enable electrical connection with electrical lines 314. The electrical lines 314 can provide power, control, and/or communication for the rail modules 302. In other embodiments, the rail modules 302 can be configured to be powered by a battery, and any controls can be automatic/automated (e.g., onboard processor) and/or can be achieved through wireless communication, as known in the art.

As shown in FIGS. 3C-3E, the rail module 302 is shown in more detail and separated from the customizable elevator handrail 300. Each rail module 302 includes a housing 316 that can house electronic and/or mechanical components that are configured to enable and provide one or more functions. The housing 316 is defined by a first contact surface 318, a second contact surface 320 opposing the first contact surface 318, an exterior function surface 322 extending between the first contact surface 318 and the second contact surface 320 on an exterior of the rail module 302, and an interior function surface 323 extending between the contact surfaces 318, 320. The contact surfaces 318, 320 are configured to contact an adjacent component, such as another rail module, a portion of a structural member, and/or a portion of a frame (e.g., as shown in FIGS. 3A-3B). As shown, the first connectors 310 are located on the first contact surface 318 and the second connectors 312 are located on the second contact surface 320. In some embodiments, the first contact surface 318, the second contact surface 320, and the interior function surface 323 define a module internal space 324 within the rail module 302, as shown in FIG. 3E. In some embodiments, the module internal space 324 can be a closed space such as a closed or enclosed chamber or cavity, partially closed chamber or cavity, or a completely open internal space, as will be appreciated by those of skilled in the art and as described herein.

The module internal space 324 defined by the contact surfaces 318, 320 and the interior function surface 323 can include one or more module components 326 to provide module functionality. The module components 326 can be electrical or mechanical components that provide one or more functions, such as speakers, lights, actuators, processors, memory, printed circuit boards, power converters, etc. The module components 326 can supply a function through one or more apertures 328 that are formed in the exterior function surface 322. The apertures 328 are selected and configured based on the function provided by the module components 326. For example, if the module components 326 are configured to supply music into an elevator car, the module components 326 can include one or more speakers and the apertures 328 can be covered with a mesh or other material to enable sound to emanate from the rail module 302. In another example, if the module components 326 are configured to provide ambient lighting in an elevator car, the apertures 328 can be configured with glass, plastic, or other material that is selected to provide a desired ambient lighting. In some embodiments, the module components 326 can include a power source, connector, or battery, a wireless communications component, a processor, memory, etc. that are all configured to provide the desired function. In various embodiments, the module components 326 can be fixedly mounted or attached to one or both of the contact surfaces 318, 320 and/or to the interior function surface 323.

As shown, in FIG. 3B, the electrical lines 314 can enter the customizable elevator handrail 300 through the first mounting frame 306 and then electrically connect with the first connectors 310 of a rail module 302. The power and/or communication can pass through the rail module 302 and then enter the structural member 304 through one or more connectors 330. The connectors 330 of the structural member 304 can provide the continuance of power/communication through the structural member 304 to another rail module 302 or to the second mounting frame 308. In some embodiments, the structural member 304 can be hollow and have wiring extending from one set of connectors 330 at one end to another set of connectors at another end of the structural member 304.

In some embodiments the connectors 310, 312 and the connectors 330 can be uniform to provide a universal connecting configuration such that the rail modules 302 can be switched out and/or replaced easily. Further, as shown, the rail modules 302 are sized and shaped to match the dimensions of the structural member 304 and/or the mounting frames 306, 308 such that the aesthetics of the customizable elevator handrail 300 may not appear different from an elevator handrail that does not include any rail modules. Although shown as a round or circular configuration, those of skill in the art will appreciate that the rail modules of the present disclosure can take any geometric shape such that they match with the handrail of the specific elevator car. Thus, in some embodiments, the housing 316 of the rail modules 302 can be rectangular, oval, square, or other geometric shape.

Turning now to FIG. 4, an alternative non-limiting configuration of a customizable elevator handrail 400 in accordance with an embodiment of the present disclosure is shown. The customizable elevator handrail 400 is similar to that shown and described above with respect to FIG. 3A-3E. The customizable elevator handrail 400 includes a first mounting frame 406 and a second mounting frame 408 with multiple rail modules 402 and a structural member 404 fixed between the mounting frames 406, 408. In the embodiment of FIG. 4, the structural member 404 has a hollow interior 432 and does not include connectors as described above. That is, electrical lines 414 can be fed into the first mounting frame 406, electrically connect to connectors 410 of the rail module 402, then connect to connectors on the other side of the rail module 402, and pass through the interior of the structural member 404. The electrical lines 414 can directly connect to another rail module 402 or can pass through the second mounting frame 408 and then enter a wall of an elevator car.

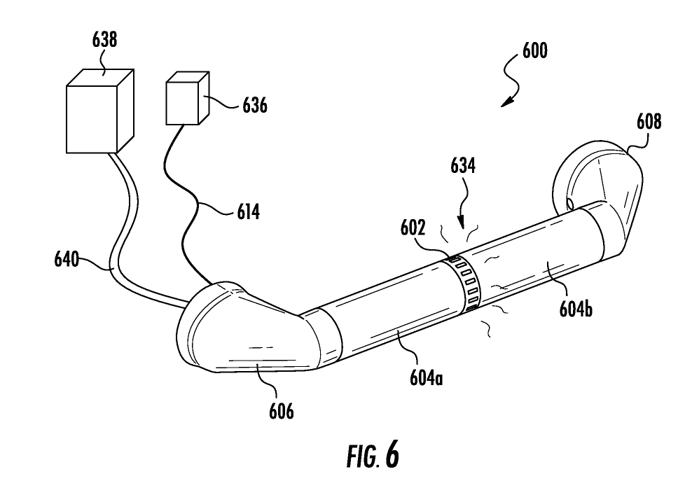

Turning now to FIG. 5, another non-limiting configuration of a customizable elevator handrail 500 in accordance with an embodiment of the present disclosure is shown. The customizable elevator handrail of the present disclosure is modifiable and modular. That is, different rail modules can be installed to provide different, multiple, or redundant functions and/or functionalities to the customizable elevator handrails. For example, as shown in FIG. 5, the customizable elevator handrail 500 includes five rail modules 502 and two structural members 504.

The customizable elevator handrail 500 includes a first rail module 502a, a second rail module 502b, a third rail module 502c, a fourth rail module 502d, and a fifth rail module 502e. The first rail module 502a connects to a first structural member 504a and can connect to a first mounting frame (not shown) when installed to an elevator panel. The second rail module 502b is connected to the opposing end of the first structural member 504a and can be wired to the first rail module 502a by wires that are within the first structural member 504a. The third rail module 502c is directly connected to the second rail module 502b on a first side and directly connected to the fourth rail module 502d on a second side. The fourth rail module 502d is further connected to a second structural member 504b, which in turn is connected to the fifth rail module 502e. Thus, the customizable elevator handrail 500 includes five rail modules 502 and two structural members 504.

Each of the rail modules 502 can provide a different or specific function, depending on the module components of each rail module. For example, in one non-limiting example, the first rail module 502a can include a speaker to provide audio therefrom, the second rail module 502b can include lighting to provide ambient light around the customizable elevator handrail 500, the third rail module 502c can include or function as a scroll wheel or touch-sensitive module (e.g., a control module), the fourth rail module 502d can be similar to the second rail module 502b and provide lighting, and the fifth rail module 502e can be a perfume or air freshener diffuser. Although various functionalities are described herein, those of skill in the art will appreciate that the rail modules of the present disclosure can be configured with any desired functionality without departing from the scope of the present disclosure.

As noted above, the third rail module 502c can be a control module. The control module can be configured to control the operation of the other rail modules of the customizable elevator handrail 500. In some embodiments, the control module functionality can be achieved through a scroll wheel configuration of the rail module. That is, a user can rotate or otherwise actuate or move the entire rail module or a portion thereof, to control one or more of the other rail modules. For example, the scroll wheel functionality can be used to adjust a volume of audio from an audio rail module or adjust a light intensity of a lighting rail module. In some embodiments, rather than a mechanical rotation (e.g., scroll wheel), the control rail module can be configured with a touch-sensitivity or a microphone for receiving input from a passenger either by touch or by spoken instructions.

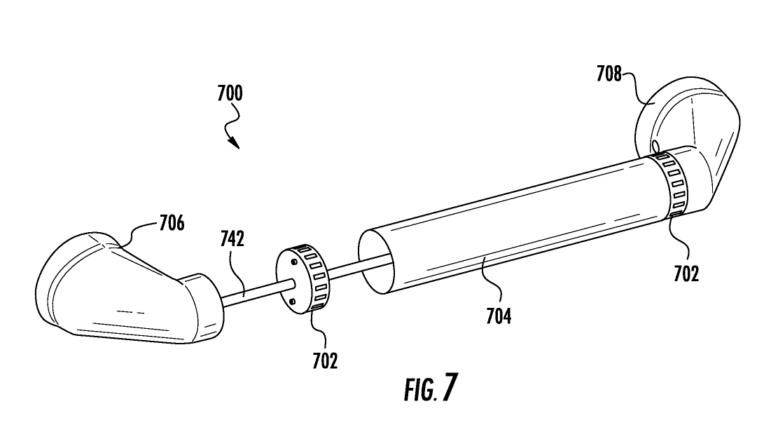

Turning now to FIG. 6, another non-limiting configuration of a customizable elevator handrail 600 in accordance with an embodiment of the present disclosure is shown. The customizable elevator handrail of the present disclosure is modifiable and modular, as described above. That is, different rail modules can be installed to provide different, multiple, or redundant functions and/or functionalities to the customizable elevator handrails. For example, as shown in FIG. 6, the customizable elevator handrail 600 includes a single rail module 602 located between two structural members 604a, 604b. The first structural member 604a is connected to a first mounting frame 606 and the second structural member 604b is connected to a second mounting frame 608.

The rail module 602, as shown, is a perfume or air freshener module configured to dispense scent 634 into the interior of an elevator car. The rail module 602, as shown, is supplied with power through an electrical line 614 from a power source 636. The power source 636 can be grid power, battery power, or other electrical power. Further, as shown in FIG. 6, the rail module 602 is connected to a scent source 638 by a feed line 640. The scent source 638 can be installed within the paneling of an elevator car, installed on top of the elevator car, or otherwise configured and installed with the elevator car.

In some embodiments, the feed line 640 and the electrical line 614 can be provided through a single line, conduit, or tubing to reduce the amount of wiring that is present in the system. Further, in some embodiments, the scent source 638 can be integrated into and contained within the housing of the rail module 602.

Turning FIG. 7, another non-limiting configuration of a customizable elevator handrail 700 in accordance with an embodiment of the present disclosure is shown. The customizable elevator handrail of the present disclosure is modifiable and modular, as described above. That is, different rail modules can be installed to provide different, multiple, or redundant functions and/or functionalities to the customizable elevator handrails. For example, as shown in FIG. 7, the customizable elevator handrail 700 includes two rail modules 702 located at opposing ends of a structural member 704. One of the rail modules 702 is connected to a first mounting frame 706 and the other of the rail modules 702 is connected to a second mounting frame 708.

As shown in FIG. 7, the customizable elevator handrail 700 includes a support element 742 extending from the first mounting frame 706 to the second mounting frame 708. The rail modules 702 and/or the structural member 704 can be attached to and supported on the support element 742. The support element 742 can be a rod or other structure that is fixedly attached between the first mounting frame 706 and the second mounting frame 708. In this embodiment, the structural member 704 can be hollow and the support element 742 can pass through the hollow interior of the structural member 704. In some embodiments, the rail modules 702 can include a central aperture through which the support element 742 can pass and thus support the rail module 702. Thus, the rail modules 702 can be directly mounted onto the support element 742. In other embodiments, the rail modules 702 can include coupling mechanisms (e.g., threaded connections) to connect to the support element 742. That is, in some embodiments, the support element 742 can be formed of multiple segments that are connected to the housings of the rail modules 702.

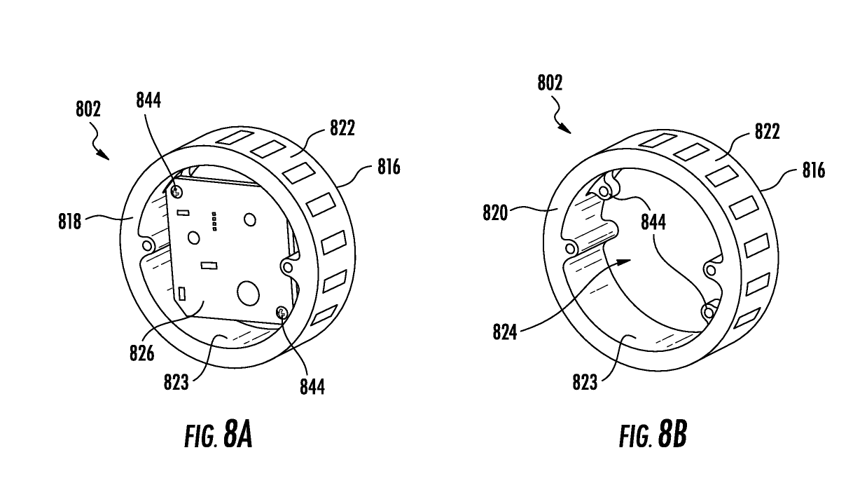

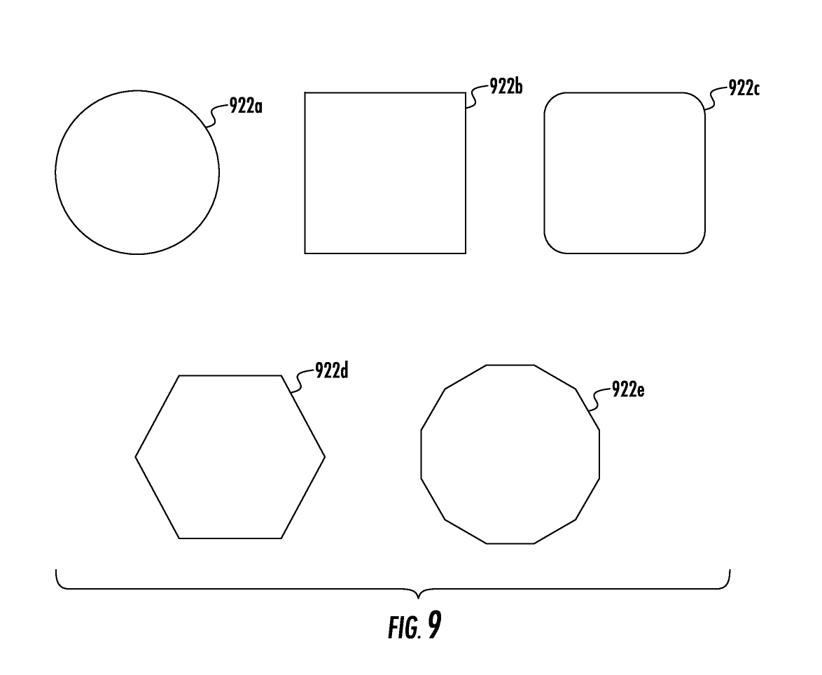

Turning now to FIGS. 8A-8B, an alternative configuration of a rail module in accordance with a non-limiting embodiment of the present disclosure is shown. FIG. 8A illustrates a rail module 802 with module components 826 installed therewith and FIG. 8B illustrates the rail module 802 with the module components 826 removed. The rail module 802 is similar to that shown and described above, having a housing 816 including a first contact surface 818, a second contact surface 820 opposing the first contact surface 818, an exterior function surface 822 extending between the contact surfaces 818, 820 on an exterior of the rail module 802, and an interior function surface 823 extending between the contact surfaces 818, 820 on an interior of the rail module 802.

As shown, a module internal space 824 is defined within the rail module 802, and particularly is defined by the interior function surface 823. As will be appreciated by those of skill in the art, the module internal space 824 is an open space or void within the rail module 802. In this embodiment, the module components 826 are mounted to the interior function surface 823 by one or more attachment elements 844, such as fasteners, clips, threaded connections, snap connections, slot connections, adhesives, etc. In some embodiments, such as shown in FIGS. 8A-8B, the module internal space 824 defines a central aperture passing through the rail module 802.

Turning now to FIG. 9, geometric schematic illustrations of various exterior function surfaces that can be used for rail modules of the present disclosure are shown. Exterior function surfaces of rail modules described herein can take any geometric shape, and the term “exterior function surface” is used to describe the entire exterior surface of a rail module. Such definition is inclusion of rail modules that have a functional aspect on only one part of the exterior function surface and even if the exterior function surface includes multiple “surfaces.” For example, as shown in FIG. 9, the geometric shapes or contours of the exterior function surfaces 922a, 922b, 922c, 922d, 922e are all included in the term “exterior function surface” and those of skill in the art will appreciate that any geometry, shape, or configuration can be used without departing from the scope of the present disclosure.

Those of skill in the art will appreciate that various example embodiments are shown and described herein, each having certain features in the particular embodiments, but the present disclosure is not thus limited. That is, features of the various embodiments can be exchanged, altered, or otherwise combined in different combinations without departing from the scope of the present disclosure. Further, additional features and/or components can be incorporated into customizable elevator handrails as provided herein without departing from the scope of the present disclosure.

Advantageously, embodiments described herein provide customizable elevator handrails that supply structural support to passengers within an elevator car while also providing additional functionality. Advantageously, one or more rail modules can be added to the handrails of an elevator car, with each module having its own function. Further, advantageously, the rail modules of the present disclosure can have the same shapes and the same interfaces in order to be able to connect the rail modules with each other and with other parts of the handrails.

Advantageously, various different functionalities can be provided with the modular customizable elevator handrails of the present disclosure. For example, some non-limiting functions of the rail modules can be perfume or air freshener diffuser or dispenser, special lighting, speakers for music, scroll wheel in order to interact with the elevator (e.g., choice of the elevator car ambiance, setup of the lighting (e.g., intensity or color of the light), choice in a predefined style of playlist music, choice of a control operating panel display theme, etc.).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although shown with various structures and configurations for the rail modules and elevator handrails, those of skill in the art will appreciate that other geometries, configurations, means of movement, etc. may be used without departing from the scope of the present disclosure.

Accordingly, the present disclosure is not to be seen as limited by the foregoing description, but is only limited by the scope of the appended claims.

What is claimed is:

1. A customizable elevator car handrail comprising:
a first mounting frame attachable to a panel of an elevator car; and
a first rail module removably attached to the first mounting frame, the first rail module having:
a housing having a first contact surface, a second contact surface opposing the first contact surface, an exterior function surface extending between the first contact surface and the second contact surface, an interior function surface extending between the first and second contact surfaces, and a module internal space defined by the housing; and
module components disposed in the module internal space of the housing and configured to provide a module functionality.

2. The customizable elevator car handrail of claim 1, wherein the exterior function surface includes at least one aperture to enable the module functionality to be provided into the elevator car.

3. The customizable elevator car handrail of claim 1, further comprising a second mounting frame attachable to the panel, wherein the rail module is removably attached between the first mounting frame and the second mounting frame.

4. The customizable elevator car handrail of claim 1, further comprising a structural member removably attached to the first mounting frame and the rail module.

5. The customizable elevator car handrail of claim 4, wherein the structural member is connected between the rail module and the first mounting frame.

6. The customizable elevator car handrail of claim 4, wherein the structural member is hollow.

7. The customizable elevator car handrail of claim 1, further comprising electrical lines installed within the first mounting frame and connecting the rail module to a power source.

8. The customizable elevator car handrail of claim 7, wherein the first contact surface of the housing includes at least one connector, the electrical lines electrically connected to the at least one connector.

9. The customizable elevator car handrail of claim 1, further comprising a second rail module attached to the first mounting frame and/or the first rail module.

10. The customizable elevator car handrail of claim 1, wherein the module functionality is at least one of (i) supplying or diffusing a scent, air freshener, or perfume, (ii) providing lighting, (iii) providing audio, or (iv) enabling passenger interaction.

11. The customizable elevator car handrail of claim 10, wherein, when the module functionality is supplying or diffusing a scent, air freshener, or perfume, the customizable elevator car handrail further comprises a scent source connected to the rail module to supply the scent, air freshener, or perfume.

12. The customizable elevator car handrail of claim 10, wherein, when the module functionality is enabling passenger interaction, the rail module is rotatable and/or a scroll wheel.

13. The customizable elevator car handrail of claim 12, wherein rotation of the rail module or scrolling of the scroll wheel adjusts a level of functionality of a different rail module.

14. The customizable elevator car handrail of claim 1, further comprising a support element installed to the first mounting frame and supporting the first rail module.

15. The customizable elevator car handrail of claim 14, wherein the housing has a central aperture and the support element passes through the central aperture to support the rail module.
